(19) United States
(12) Patent Application Publication
(10) Pub. No.: US 2009/0070118 A1
(43) Pub. Date: Mar. 12, 2009

(54) AUDIO CODING AND DECODING

(75) Inventors: Albertus Cornelis Den Brinker, Eindhoven (NL); Felipe Riera Palou, Palma de Mallorca (ES); Arnoldus Werner Johannes Oomen, Eindhoven (NL); Jean-Bernard Herve Marie Rault, Acigne (FR); David Sylvain Thierry Virette, Lannion (FR); Pierrick Jean-Louise Marie Philippe, Melesse (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/718,611

(22) PCT Filed: Nov. 3, 2005
(86) PCT No.: PCT/IB2005/053591

§ 371 Date: May 4, 2007

(30) Foreign Application Priority Data
Nov. 9, 2004 (EP) 04105633.4

(51) Int. Cl. G10L 19/00

(52) U.S. Cl. 704/500

(57) ABSTRACT

An audio encoding device (100) comprises first encoding means (101, 111) for encoding transient signal components and/or sinusoidal signal components of an audio signal (x(n)) and producing a residual signal (z(n)), and second encoding means for encoding the residual signal. The second encoding means comprise filter means (122) for selecting at least two frequency bands of the residual signal. The selected frequency bands (LF, HF) of the residual signal (z(n)) are encoded by a first encoding unit (123) and a second encoding unit (124) respectively. The first encoding unit (123) may comprise a waveform encoder, such as a time-domain encoder, while the second encoding unit (124) may comprise a noise encoder.

The present invention relates to audio coding and decoding. More in particular, the present invention relates to an audio encoding device comprising first encoding means for encoding transient signal components and/or sinusoidal signal components of an audio signal and producing a residual signal, and second encoding means for encoding the residual signal. The present invention also relates to an audio decoding device, a method of encoding an audio signal and a method of decoding an audio signal.

It is well known to encode audio signals in order to reduce the bandwidth required for transmission or storage of the signals. Various encoding techniques are in use, most of these techniques being suited for a particular class of signals. Different encoding techniques may be applied in succession to the same signals to efficiently encode different signal components. For example, the transient signal components of an audio signal may be encoded, after which the encoded signal components are subtracted from the original audio signal. Then the sinusoidal signal components of the resulting signal may be encoded and subsequently be subtracted to yield a residual signal. This residual signal is typically considered to constitute a noise signal and may be encoded as such, for example by defining the residual signal on the basis of its stochastic properties (e.g. power, probability density function, power spectral density function, and/or spectro-temporal envelope).

An example of an arrangement as described above is disclosed in United States Patent Application No. US 2001/0032087 (Oomen et al./Philips), the entire contents of which are herewith incorporated in this document.

It has been found, however, that the residual signal mentioned above is often not a typical noise signal. Due to coding errors, it is possible that not all transient and sinusoidal signal components are removed from the original audio signal. As a result, the residual signal typically contains some of these components, in addition to “pure” noise. Applying a noise model to such a residual signal will therefore cause further coding errors, resulting in audible signal distortion at the decoder.

It is an object of the present invention to overcome these and other problems of the Prior Art and to provide an audio encoding device and method that encode the signal with improved accuracy.

It is another object of the present invention to provide a decoding device and method capable of decoding an audio signal that has been encoded with improved accuracy.

Accordingly, the present invention provides an audio encoding device, comprising first encoding means for encoding transient signal components and/or sinusoidal signal components of an audio signal and producing a residual signal, and second encoding means for encoding the residual signal, wherein the second encoding means comprise filter means for selecting at least one frequency band of the residual signal, and wherein the second encoding means further comprise at least a first encoding unit and a second encoding unit for encoding the selected frequency band and an additional frequency band of the residual signal respectively.

By encoding the residual signal per frequency band, a much better match between the encoding technique(s) and the respective frequency band may be obtained. It is possible to vary encoding parameters between frequency bands, or even to apply different encoding techniques to the various frequency bands. As a result, the encoding error of the residual signal and the corresponding signal distortion are significantly reduced.

In particular, a selected frequency band may contain mainly coding artifacts and may be encoded using a first encoding technique (for example waveform coding), while another (e.g. remaining) frequency band may contain mainly noise and may be encoded using a second, different encoding technique (for example noise coding). By using different first and second encoding units, an improved coding accuracy is achieved.

In a preferred embodiment, the selected (or first) frequency band comprises a relatively low part of the frequency spectrum of the signal while the additional (or second) frequency band comprises a relatively high part. These parts of the frequency spectrum (frequency bands) may or may not have some overlap. It will be understood that more than two frequency bands may be selected, for example three, four or five. The frequency bands may together substantially constitute the entire residual signal, although embodiments are possible in which some frequencies of the residual signal may not be encoded for efficiency reasons. The additional (or second) frequency band may comprise substantially the entire frequency range of the residual signal, but may also be selected by filter means and be substantially narrower than the entire frequency range.

The present inventors have realized that the high frequency part of the residual signal typically is a good approximation of a “pure” noise signal and may therefore be modeled as a noise signal, while the low frequency part deviates from the noise model. In particular, the low frequency part of the residual signal typically contains artifacts due to coding errors. Such artifacts may include remaining transients and sinusoidal signal components.

Accordingly, the first encoding unit may advantageously comprise a waveform encoder while the second encoding unit may comprise a noise encoder. This is particularly advantageous when audio encoding device is arranged such that the first encoding unit encodes a frequency band containing a lower part of the frequency spectrum and the second encoding unit encodes a frequency band containing a higher part.

A particularly suitable waveform encoding technique is Analysis-by-Synthesis encoding. Accordingly, it is preferred that the first encoding unit comprises an Analysis-by-Synthesis encoder. More in particular, it is preferred that the first encoding unit comprises a Regular Pulse Excitation (RPE) encoder, a Multiple Pulse Excitation (MPE) encoder, a Code-Excited Linear Prediction (CELP) encoder, or any combination thereof. These encoders, which are time-domain encoders, are typically used for speech and employ speech models. For this reason, they cannot be used for audio signals in general. However, the present inventors have realized that speech encoders may be used for encoding selected frequency bands of the residual signal. Suitable speech encoder techniques further include delta modulation and adaptive differential pulse code modulation (ADPCM). An RPE or MPE encoder may comprise a linear prediction stage.

It is preferred that the filter means comprise a band splitter or a quadrature mirror filter bank. Such an arrangement allows an efficient selection of the frequency bands.

The first encoding means may comprise a transient parameter extraction unit coupled to a transient synthesis unit and a first combination unit, and a sinusoids parameter extraction unit coupled to a sinusoids parameter synthesis unit and a second combination unit.

The audio encoding device may further comprise a combining and multiplexing unit for combining and multiplexing signals produced by the first encoding means and the second encoding means.

The present invention also provides an audio decoding device for decoding an audio signal coded by a device as defined above, the decoding device comprising first decoding means for decoding the transient signal components and/or the sinusoidal signal components of the audio signal, and second decoding means for decoding the residual signal, wherein the second decoding means comprise at least a first decoding unit and a second decoding unit for decoding a first frequency band and a second frequency band of the residual signal respectively, and a mixing unit for mixing the decoded first frequency band and second frequency band of the residual signal.

The first decoding unit may advantageously comprise a waveform decoder while the second decoding unit comprises a noise decoder. More in particular, the first decoding unit may comprise an Analysis-by-Synthesis decoder, and more specifically a Regular Pulse Excitation (RPE) decoder, a Multiple Pulse Excitation (MPE) decoder and/or a Code-Excited Linear Prediction (CELP) decoder.

In a particularly advantageous embodiment, the audio decoding device further comprises a third decoder unit for also decoding the first frequency band and/or the second frequency band, which third decoder unit utilizes a different decoding technique from the first and/or second decoder unit. This allows the substantially simultaneous use of alternative decoding techniques. In addition, switching means may be provided for selectively connecting either the first decoding unit or the third decoding unit to the mixing unit. This allows the decoder to select the decoded signal from either decoding unit, for example on the basis of a signal quality measurement or an external control signal. This embodiment allows the decoding of a scalable bit stream.

The third decoding unit may be provided with a further filter unit for selecting frequency bands of the signal decoded by the third decoding unit. That is, the decoded signal output by the third decoding unit may be split into several frequency bands, while each of those frequency bands may be selectively used instead of a corresponding frequency band decoded by another decoder unit, for example the first decoder unit mentioned above.

The present invention additionally provides an audio transmission system, comprising an audio encoding device and an audio decoding device as defined above.

The present invention also provides a method of encoding an audio signal, the method comprising the steps of encoding transient signal components and/or sinusoidal signal components of the audio signal and producing a residual signal, and encoding the residual signal, wherein the step of encoding the residual signal comprises the sub-steps of selecting a frequency band of the residual signal, and encoding the selected frequency band and an additional frequency band of the residual signal separately.

The selected (or first) frequency band may comprise relatively low frequencies while the additional (or second) frequency band may comprise relatively high frequencies. The additional frequency band may comprise the entire frequency range of the residual signal, or a selected, limited frequency band.

The step of encoding the selected frequency band may comprise waveform encoding while the step of encoding the additional frequency band may comprise noise encoding. More in particular, the step of encoding the selected frequency band may comprise Analysis-by-Synthesis encoding, and more specifically Regular Pulse Excitation (RPE) encoding, Multiple Pulse Excitation (MPE) encoding and/or Code-Excited Linear Prediction (CELP) encoding.

Other embodiments of the audio encoding method of the present invention will become apparent from the description of the invention.

Furthermore, the present invention provides a method of decoding an audio signal, the method comprising the steps of decoding transient signal components and/or sinusoidal signal components of the audio signal, and decoding a residual signal, wherein the step of decoding the residual signal comprises the sub-steps of decoding a first frequency band and a second frequency band of the residual signal separately, and combining the thus decoded frequency bands.

The sub-step of decoding a first frequency band may advantageously comprise waveform decoding while the sub-step of decoding a second frequency band may comprise noise decoding. More in particular, the sub-step of decoding a first frequency band may comprise Analysis-by-Synthesis decoding, more specifically Regular Pulse Excitation (RPE) decoding, Multiple Pulse Excitation (MPE) decoding and/or Code-Excited Linear Prediction (CELP) decoding.

The audio decoding method of the present invention may further comprise the sub-step of additionally decoding the first frequency band and/or the second frequency band utilizing a different decoding technique. Additionally, the method may further comprise the sub-step of selectively using either the originally decoded frequency band or the additionally decoded frequency band.

The present invention additionally provides a computer program product for carrying out the method defined above. A computer program product may comprise a set of computer executable instructions (computer program) stored on an information carrier, such as a CD (Compact Disk), a DVD (Digital Versatile Disk), a floppy disk, or any other suitable medium. Alternatively, the set of computer executable instructions may be downloaded from a remote server, for example via the Internet. The set of computer executable instructions, which allows the computer to carry out the method of the present invention, may be provided in machine language, assembly language or a higher programming language such as C++ or Java. Any computer executable program that is capable of carrying out the essential method steps of the present invention is deemed to constitute a computer program product as mentioned above. The particular type of computer necessary to carry out the computer program of the present invention is not relevant.

The present invention will further be explained below with reference to exemplary embodiments illustrated in the accompanying drawings, in which:

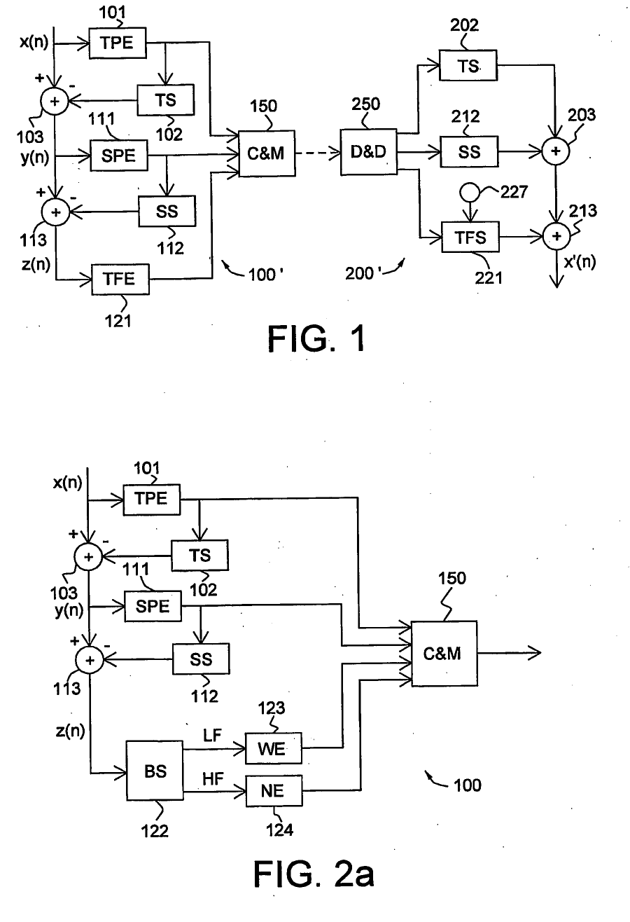

FIG. 1 schematically shows a transmission system comprising an encoder and a decoding device according to the Prior Art.

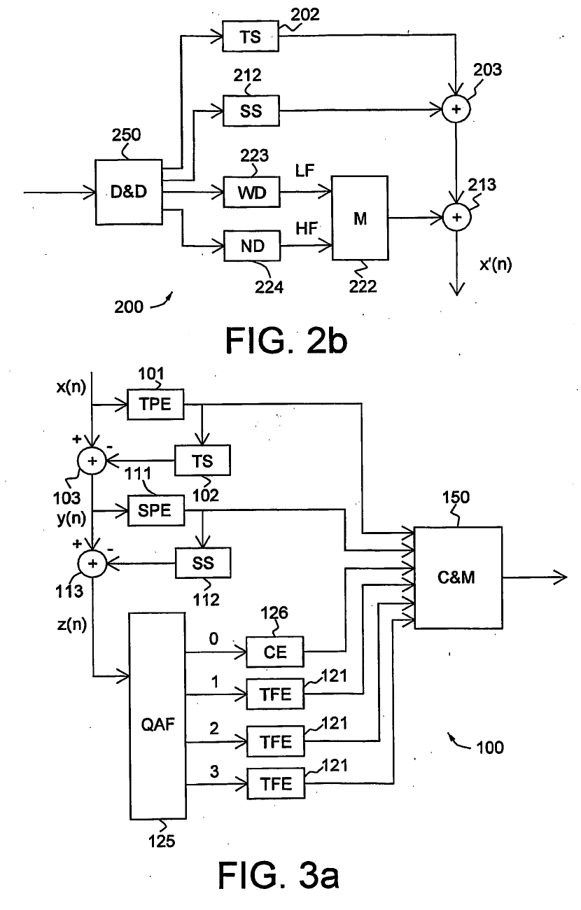

FIG. 2a schematically shows a first embodiment of an encoding device according to the present invention.

FIG. 2b schematically shows a first embodiment of a decoding device according to the present invention.

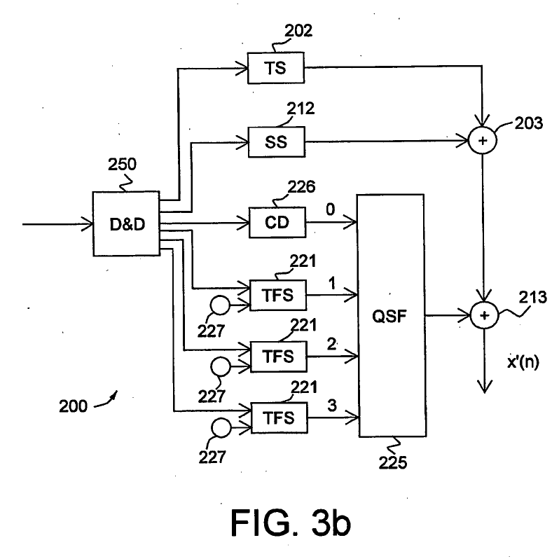

FIG. 3a schematically shows a second embodiment of an encoding device according to the present invention.

FIG. 3b schematically shows a second embodiment of a decoding device according to the present invention.

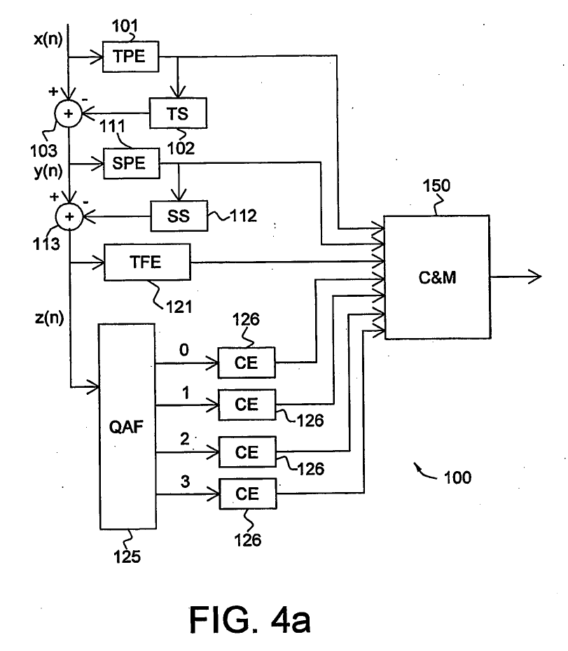

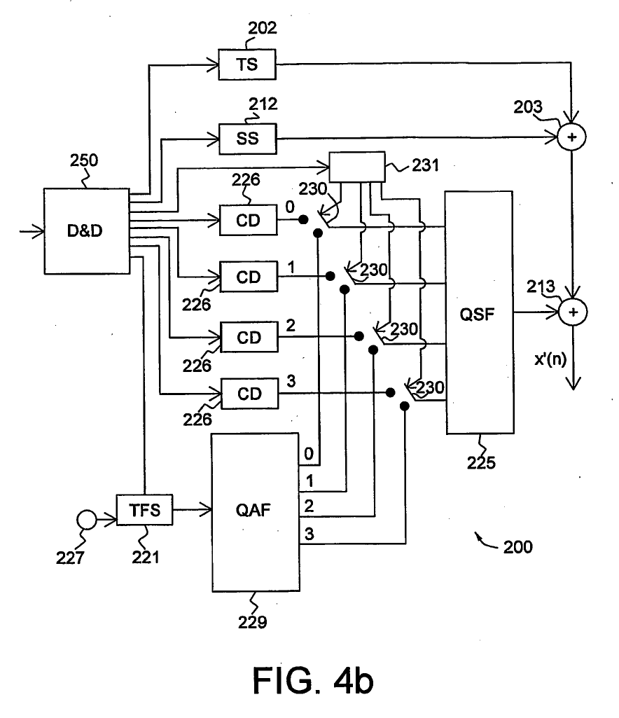

FIG. 4a schematically shows a third embodiment of an encoding device according to the present invention.

FIG. 4b schematically shows a third embodiment of a decoding device according to the present invention.

The transmission system shown merely by way of non-limiting example in FIG. 1 comprises an audio encoding device 100′ and an audio decoding device 200′. The audio encoder device 100′ of the Prior Art, also known as a “parametric audio coder”, encodes the audio signal x(n) in three stages. An audio transmission system of this type is disclosed in the above-mentioned United States Patent Application No. US 2001/0032087.

In the first stage, any transient signal components in the audio signal x(n) are encoded using the transients parameter extraction (TPE) unit 101. The parameters are supplied to both a combining and multiplexing (C&M) unit 150 and a transients synthesis (TS) unit 102. While the combining and multiplexing unit 150 suitably combines and multiplexes the parameters for transmission to the decoder 200′, the transients synthesis unit 102 reconstructs the encoded transients. These reconstructed transients are subtracted from the original audio signal x(n) at the first combination unit 103 to form an intermediate signal y(n) from which the transients are substantially removed.

In the second stage, any sinusoidal signal components (that is, sines and cosines) in the intermediate signal y(n) are encoded by the sinusoids parameter extraction (SPE) unit 111. The resulting parameters are fed to the combining and multiplexing unit 150 and to a sinusoids synthesis (SS) unit 112. The sinusoids reconstructed by the sinusoids synthesis unit 112 are subtracted from the intermediate signal y(n) at the second combination unit 113 to yield a residual signal z(n).

In the third stage, the residual signal z(n) is encoded using a time/frequency envelope data extraction (TFE) unit 121. It is noted that the residual signal z(n) is assumed to be a noise signal, as transients and sinusoidals are removed in the first and second stage. An overview of noise modeling and encoding techniques according to the Prior Art is presented in Chapter 5 of the dissertation “Audio Representations for Data Compression and Compressed Domain Processing”, by S. N. Levine, Stanford University, USA, 1999.

The parameters resulting from all three stages are suitably combined and multiplexed by the combining and multiplexing (C&M) unit 150, which may also carry out additional coding of the parameters, for example Huffman coding or time-differential coding, to reduce the bandwidth required for transmission. It is noted that the parameter extraction (that is, encoding) units 101, 111 and 121 may carry out a quantization of the extracted parameters. Alternatively or additionally, a quantization may be carried out in the combining and multiplexing (C&M) unit 150.

After having been combined and multiplexed (and optionally encoded and/or quantized) in the C&M unit 150, the parameters are transmitted via a transmission medium, as schematically indicated in FIG. 1 by an arrow between the units 150 and 250. The transmission medium may involve a satellite link, a glass fiber cable, a copper cable, and/or any other suitable medium.

It is noted that x(n), y(n) and z(n) are digital signals, n representing the sample number.

The decoding device 200′ of FIG. 1 decodes the transmitted signal parameters in three stages corresponding to the stages of the encoding. After receiving, demultiplexing and decombining the signal parameters in the demultiplexing and decombining unit 250, transient parameters are supplied to a transients synthesis (TS) unit 202 which reconstructs the transients in the signal, similar to the counterpart unit 102 in the encoding device 100′. Sinusoid parameters are used to reconstruct sinusoids in the sinusoids synthesis (SS) unit 212, similar to the counterpart unit 112. The reconstructed transients and sinusoids are combined in a first combination unit 203.

The noise parameters (time and/or frequency envelope data) are used by the time/frequency shaping (TFS) unit 221 which is coupled to a noise generator 227. The reconstructed residual signal is combined with the reconstructed transients and sinusoids in the second combination unit 213 to produce a reconstructed audio signal x′(n).

This Prior Art transmission system works well if the original audio signal can be modeled accurately, in particular, if the residual signal z(n) contains only “true” noise. However, in practice this is often not the case. Errors in the signal modeling and parameter extraction in the first two stages may cause the residual signal z(n) to still contain traces of transients and sinusoids. In addition, the original audio signal x(n) may have a structure that cannot easily be decomposed into constituent signal components. As a result, the residual signal z(n) is not a true noise signal and, accordingly, cannot be properly modeled as a noise signal. The envelope data extracted by the TFE unit 121 may therefore be inaccurate, leading to an incorrect reconstruction of the residual signal in the decoder 200′ and a perceptually incorrect (that is, distorted) reconstructed audio signal x′(n).

The present invention solves this problem by providing an improved encoding of the residual signal x(n), resulting in a greatly reduced distortion in the reconstructed audio signal x′(n). An embodiment of an encoding device according to the present invention is schematically depicted in FIG. 2a, while the corresponding decoding device is illustrated in FIG. 2b.

The inventive encoding device 100 shown merely by way of non-limiting example in FIG. 2a also comprises a transients parameter extraction (TPE) unit 101, a transients synthesis (TS) unit 102, a first combination unit 103, a sinusoids parameter extraction (SPE) unit 111, a sinusoids synthesis (SS) unit 112, a second combination unit 113, and a combining and multiplexing (C&M) unit 150. However, the single time/frequency envelope data extraction (TFE) unit 121 is replaced with a band splitter (BS) 122, a first encoding unit 123 and a second encoding unit 124. The band splitter 122 filters the residual signal z(n), splitting it up into multiple pass bands, in the example shown labeled LF (low frequency) and HF (high frequency) respectively.

By splitting the residual signal up into multiple frequency bands, it is possible to adapt the encoding units to their respective frequency bands. It will be understood that each frequency band of the residual signal may have particular properties, and that the encoding units may be adapted to those properties to optimally encode the residual signal. It will further be understood that three, four, five, six or more frequency bands and associated encoder units may also be utilized.

In the embodiment shown in FIG. 2a, the first (LF) encoding unit 123 is a time-domain encoding unit, in particular a coding unit using speech coding techniques. Those skilled in the art will recognize that speech coding and audio coding in general typically require very different coding techniques. Speech coding typically uses models of the human vocal tract to analyze the speech signals, while such models are not applicable to sound in general and would lead to signal distortion when applied to arbitrary audio signals. However, the present inventors have realized that speech coding techniques are very suitable for encoding the low frequency part (or parts) of the residual signal of the encoding device in question.

The (first) encoding unit 123 is, in the present example, constituted by a waveform encoder (WE), for example an Analysis-by-Synthesis (AS) encoder, and may more particularly comprise an RPE (Regular-Pulse Excitation), an MPE (Multiple Pulse Excitation) and/or CELP (Code-Excited Linear Prediction) encoder. For these and other coding techniques, reference is made to the paper “Speech Coding: A Tutorial Review” by A. S. Spanias, Proceedings of the IEEE, Vol. 82, No. 10, October 1994, the entire contents of which are herewith incorporated in this document.

The (second) encoding unit 124 is a “regular” noise encoder. Such an encoder represents the signal in one or more stochastic terms (parameters), such as power, power spectral density function, and/or spectro-temporal envelope. Those skilled in the art will realize that these parameters may be determined using well-known techniques, such as Laguerre filtering for determining the frequency envelope and Linear Predictive Coding (LPC) for determining the time envelope of the (noise) signal.

The second encoding unit 124 encodes, in the present example, the HF (high frequency) part of the residual signal z(n). The present inventors have realized that the high frequency part of the residual signal consists substantially of “true” noise which may be efficiently encoded using a noise encoder. The LF (low frequency) part of the residual signal z(n), however, has been found to contain remnants of transients and sinusoids that are not compatible with noise encoding techniques but can suitably be encoded using, for example, speech coding techniques. By using the “hybrid” coding technique of the present invention, a very accurate coding of the residual signal can be achieved.

The parameters produced by the first encoding unit 123 and the second encoding unit 124 are supplied to the combining and multiplexing unit 150, together with the signal parameters produced by the transients parameter extraction (TPE) unit 101 and the sinusoids parameter extraction (SPE) unit 111. The combined and multiplexed parameters may then be transmitted over a suitable transmission path, for example as a parametric bit stream. Such a bit stream could, for example, consist of four sections: header, transient parameters, sinusoids parameters, and noise (=residual signal) parameters.

In the embodiment of FIG. 2a, the transients parameter extraction (TPE) unit 101 and the sinusoids parameter extraction (SPE) unit 111 operate on the entire frequency spectrum of the audio signal x(n), whereas the first encoding unit 123 and the second encoding unit 124 operate upon selected parts of the frequency spectrum, the selection being effected by the band splitter (BS) 122. Accordingly, a frequency-independent encoding of the transient and sinusoidal signal components, and a frequency-dependent encoding of the residual signal is achieved. In addition, this frequency-dependent encoding is performed by distinct encoding units utilizing different encoding techniques.

An exemplary decoding device 200 in accordance with the present invention is schematically illustrated in FIG. 2b. The device 200 of FIG. 2b is designed to decode audio signals that have been encoded by the device 100 of FIG. 2a.

The decoding device 200 of FIG. 2b is similar to the Prior Art decoding device 200′ of FIG. 1 and also comprises a demultiplexing and decombining unit 250, a transients synthesis (TS) unit 202, a sinusoids synthesis (SS) unit 212, a first combination unit 203 and a second combination unit 213. However, in contrast to the decoding device 200′ of the Prior Art, the inventive decoding device 200 shown in FIG. 2b comprises a first decoder unit 223 and a second decoder unit 224 arranged in parallel and coupled to a mixing unit 222. The first decoder unit 223 receives a first part of the parameters representing the residual signal, in the present example the low frequency (LF) part. Similarly, the second decoder unit 224 receives a second part of the parameters representing the residual signal, in the present example the high frequency (HF) part. These distinct sets of signal parameters are decoded separately in the respective decoder units 223 and 224, and the resulting parts of the residual signal are suitably mixed by the mixing unit 222 to form the reconstructed residual signal. The second combination unit 213 combines this reconstructed residual signal with the reconstructed transient and sinusoid signal components to form the reconstructed audio signal x′(n).

It will be understood that the two combination units 203 and 213 may be combined into a single combination unit having multiple inputs. Embodiments may be envisaged in which the combination units are integrated in the mixing unit 222.

In the embodiment shown, the first decoder unit 223 is a waveform decoder (WD) while the second decoder unit 224 is constituted by a noise decoder (ND). In general, the decoder units 223 and 224 will be chosen so as to match the corresponding encoder units in the encoding device 100. The waveform decoder of the decoder unit 223 may, depending on the corresponding encoder, be an Analysis-by-Synthesis decoder, and more specifically an RPE (Regular-Pulse Excitation), an MPE (Multi-Pulse Excitation) and/or CELP (Code-Excited Linear Prediction) decoder.

By encoding and decoding two or more frequency bands of the residual signal separately, a much more accurate reconstruction of the residual signal x(n) is obtained.

An alternative embodiment of the encoding device 100 of the present invention is illustrated in FIG. 3a, where the band splitter 122 is replaced with a QMF (Quadrature Mirror Filter) Analysis Filter (QAF) bank 125. This filter bank separates the residual signal z(n) into four frequency bands labeled 0-3 in FIG. 3a. In the embodiment shown, the lowest frequency band (band 0) is encoded by a CELP (Code-Excited Linear Prediction) encoder (CE) unit 126, while the other frequency bands are encoded by time/frequency envelope data extraction (TFE) units 121. It is noted that these TFE units 121 may each be identical to the Prior Art TFE unit 121 illustrated in FIG. 1. However, in the Prior Art encoding device, only a single TFE unit 121 was used, while in the encoding device of the present invention, a TFE unit 121 is arranged in parallel with at least one other encoder unit, each encoder unit being associated with a particular frequency band. In the example shown, three TFE units 121 are arranged in parallel to a CE (CELP Encoder) unit 126. All these encoder units are coupled to the combining and multiplexing (C&M) unit 150, together with the transients parameter extraction (TPE) unit 101 and the sinusoids parameter extraction (SPE) unit 111.

Those skilled in the art will realize that the QMF Analysis Filter (QAF) bank 125 provides an efficient implementation of a filter bank, but that alternative filter arrangements may be used to obtain comparable results. Similarly, the choice of a single CELP encoder unit 126 and three TFE units 121 may depend on the particular frequency bands selected by the QMF Analysis Filter Bank 125 (or its equivalent). The present inventors have realized that lower frequencies of the residual signal may be encoded accurately and efficiently using waveform encoding, such as CELP or RPE encoding, while higher frequencies may suitably be encoded using (time and/or frequency) envelope data extraction. The reason for this is that the lower frequencies may contain remnants of transients and sinusoids and possibly coding artifacts, while the higher frequencies more resemble “pure” noise.

It will be understood that the CELP encoder unit 126 may be replaced with another encoder unit, for example an RPE encoder unit, an MPE encoder unit, or another waveform encoding unit.

A decoder device corresponding with the encoder device of FIG. 3a is schematically shown in FIG. 3b. The exemplary decoding unit 200 of FIG. 3b contains a CELP decoder (CD) unit 226 and three time/frequency shaping (TFS) units 221. Each time/frequency shaping (TFS) unit 221 is coupled to a noise generator 227 (it will be understood that a single noise generator 227 may be used to generate the noise signals for all time/frequency shaping units 221).

The CELP decoder unit 226 and the three time/frequency shaping units 221 receive signal parameters from the demultiplexing and decombining (D&D) (and optionally decoding) unit 250 to reconstruct the respective frequency bands (labeled 0-3 in FIG. 3b) of the residual signal. The reconstructed partial signals are fed to the QMF (Quadrature Mirror Filter) Synthesis Filter (QSF) bank 225, where the residual signal is reconstructed. This reconstructed residual signal is then fed to the (second) combination unit 213 to produce the reconstructed audio signal x′(n).

The encoder unit 100 of FIG. 4a also has a QMF (Quadrature Mirror Filter) Analysis Filter (QAF) bank 125 which separates the residual signal z(n) into four frequency bands (labeled 0-3). In contrast to FIG. 3a, the embodiment of FIG. 4a also has a time/frequency envelope data extraction (TFE) unit 121 coupled between the second combination unit 113 and the combining and multiplexing (C&M) unit 150, that is, in parallel to the QMF Analysis Filter bank 125 and the encoder units 126. In this particularly advantageous embodiment, the residual signal z(n) is initially noise coded as in the Prior Art, but is also waveform coded, per frequency band, by the encoder units 126. The combining and multiplexing unit 150 may be arranged such that some of the parameters produced by the time/frequency envelope data extraction unit 121 may be overwritten by the encoder units 126. In that case, the (CELP or equivalent) encoder units 126 serve to provide improved signal parameters while the TFE unit 121 serves to provide basic signal parameters. Alternatively, the parameters from both the TFE unit 121 and the CELP encoder units 126 may be transmitted.

The combined and multiplexed parameters may be arranged as a scalable bit stream. Such a bit stream may, for example, consist of eight sections: header, transients parameters, sinusoid parameters, noise parameters, and four additional sections for CELP (or equivalent) parameters. A bit stream having this structure may be truncated before or after each CELP parameters section. It is noted that each CELP parameters section may be viewed as an enhancement layer for enhancing the audio transmitted in the base layer constituted by the first four sections.

The combining and multiplexing unit 150 may transmit information indicating which encoder unit (that is, which of the four CE units 126, or the TFE unit 121) was used to produce certain parameters. This encoder information allows the decoding device to select an appropriate decoder unit. Alternatively, the decoding device makes this selection on the basis of the transmitted parameters. For example, when the energy of a certain frequency band at the QMF Analysis Filter bank 229 is significantly greater than the energy of the same band at the CELP decoder 226, then the QMF Analysis Filter bank 229 should be selected for that particular frequency band.

It is noted that only a single CELP encoder (CE) unit 126 may be present to already provide an improvement over the Prior Art. In such an embodiment, the single CELP encoder unit 126 may encode the entire frequency range of the residual signal z(n), or only a selected frequency band thereof. Alternatively, two or three CELP encoder units 126 may be provided, each for encoding an associated frequency band. Advantageously, the CELP encoder unit 126 of the highest frequency band may be omitted, as this frequency band is most likely to contain a signal resembling “pure” noise.

It is further noted that the encoder units 126 may each also comprise an RPE, MPE or other encoder (in general: waveform encoder), instead of (or in addition to) a CELP encoder.

A decoder device corresponding with the encoder device of FIG. 4a is schematically shown in FIG. 4b. The exemplary decoding unit 200 of FIG. 4b contains a plurality of CELP decoder (CD) units 226, each for a selected frequency band (labeled 0-3). In addition, a time/frequency shaping (TFS) unit 221 (coupled to a noise generator 227) is arranged in parallel to the decoder units 226. The (residual) signal reconstructed by the time/frequency shaping (TFS) unit 221 is fed to a QMF Analysis Filter (QAF) bank 229 which separates the signal into a plurality of frequency bands (labeled 0-3). A set of switches 230 is capable of connecting either a CELP decoder unit 226 or the QMF Analysis Filter bank 229 to the QMF Synthesis Filter (QSF) bank 225. The switches 230 are individually controlled by a switch control unit 231 that receives selection information from the demultiplexing and decombining unit 250. Accordingly, each frequency band may be decoded using either the time/frequency shaping (TFS) unit 221 or a CELP decoder (CD) unit 226. Alternatively, the switch control unit 231 may be provided with a signal quality test unit for measuring the residual signal quality and controlling the switches 230 in accordance with the measured signal quality.

It will be understood that the CELP decoder units 226 may individually or collectively be replaced with equivalent decoder units, such as RPE or MPE decoder units. Further modifications may be made, for example, the time/frequency shaping (TFS) unit 221 may be integrated in the QAF unit 229.

The present invention is based upon the insight that after subtracting transients and sinusoids from an audio signal, the residual signal is not a “pure” noise signal and cannot be accurately coded as such. The present invention benefits from the further insight that the residual signal can be encoded with greater accuracy by encoding the residual signal per frequency band. This further allows to make the particular encoding technique used dependent on the frequency band.

It is noted that any terms used in this document should not be construed so as to limit the scope of the present invention. In particular, the words “comprise(s)” and “comprising” are not meant to exclude any elements not specifically stated. Single (circuit) elements may be substituted with multiple (circuit) elements or with their equivalents.

It will be understood by those skilled in the art that the present invention is not limited to the embodiments illustrated above and that many modifications and additions may be made without departing from the scope of the invention as defined in the appending claims.

1. An audio encoding device (100), comprising first encoding means (101, 111) for encoding transient signal components and/or sinusoidal signal components of an audio signal and producing a residual signal, and second encoding means for encoding the residual signal, wherein the second encoding means comprise filter means (122, 125) for selecting at least one frequency band of the residual signal, and wherein the second encoding means further comprise at least a first encoding unit (123, 126) and a second encoding unit (124, 121) for encoding the selected frequency band and an additional frequency band of the residual signal respectively.

2. The audio encoding device according to claim 1, wherein the filter means (122, 125) are arranged such that the selected frequency band (LF; 0) comprises relatively low frequencies and the additional frequency band (HF; 1) comprises relatively high frequencies.

3. The audio encoding device according to claim 1, wherein the filter means (122, 125) are arranged for also selecting the additional frequency band (HF; 1).

4. The audio encoding device according to claim 1, wherein the additional frequency band (HF; 1) comprises substantially the entire frequency range of the residual signal.

5. The audio encoding device according to claim 1, wherein the first encoding unit (123, 126) comprises a waveform encoder and wherein the second encoding unit (124, 121) comprises a noise encoder.

6. The audio encoding device according to claim 5, wherein the first encoding unit (123, 126) comprises an Analysis-by-Synthesis (AS) encoder.

7. The audio encoding device according to claim 5, wherein the first encoding unit (123, 126) comprises a Regular Pulse Excitation (RPE) encoder, and/or a Multiple Pulse Excitation (MPE) encoder, and/or a Code-Excited Linear Prediction (CELP) encoder.

8. The audio encoding device according to claim 1, wherein the filter means comprise a band splitter (122) or a Quadrature Mirror Filter (QMF) bank (125).

9. The audio encoding device according to claim 1, wherein the first encoding means comprise a transient parameter extraction unit (101) coupled to a transient synthesis unit (102) and a first combination unit (103), and a sinusoids parameter extraction unit (111) coupled to a sinusoids parameter synthesis unit (112) and a second combination unit (113).

10. The audio encoding device according to claim 1, further comprising a combining and multiplexing unit (150) for combining and multiplexing signals produced by the first encoding means and the second encoding means.

11. An audio decoding device (200) for decoding an audio signal encoded by an audio encoding device (100) according to claim 1, the decoding device comprising first decoding means for decoding the transient signal components and/or the sinusoidal signal components of the audio signal, and second decoding means for decoding the residual signal, wherein the second decoding means comprise at least a first decoding unit (223, 226) and a second decoding unit (224, 221) for decoding a first frequency band (LF; 0) and a second frequency band (HF; 1) of the residual signal respectively, and a mixing unit (222, 225) for mixing the decoded first frequency band and second frequency band of the residual signal.

12. The audio decoding device according to claim 11, wherein the first decoding unit (223, 226) comprises a waveform decoder and the second decoding unit (224, 221) comprises a noise decoder.

13. The audio decoding device according to claim 12, wherein the first decoding unit (223, 226) comprises an Analysis-by-Synthesis (AS) decoder.

14. The audio decoding device according to claim 12, wherein the first decoding unit (223, 226) comprises a Regular Pulse Excitation (RPE) decoder, a Multiple Pulse Excitation (MPE) decoder, and/or a Code-Excited Linear Prediction (CELP) decoder.

15. The audio decoding device according to claim 11, wherein the mixing unit is constituted by a Quadrature Mirror Filter (QMF) synthesis filter bank (225).

16. The audio decoding device according to claim 11, further comprising a third decoder unit (221) for also decoding the first frequency band (LF; 0) and/or the second frequency band (HF; 1), which third decoder unit (221) utilizes a different decoding technique from the first and/or second decoder unit.

17. The audio decoding device according to claim 16, further comprising switching means (230) for selectively connecting either the first decoding unit (226) or the third decoding unit (221) to the mixing unit (222, 225).

18. The audio decoding device according to claim 11, wherein the third decoding unit (221) is provided with a further filter unit (229) for selecting frequency bands of the signal decoded by the third decoding unit.

19. The audio decoding device according to claim 11, wherein the first decoding means comprise a transient synthesis unit (202) and a first combination unit (203), and a sinusoids parameter synthesis unit (212) and a second combination unit (213).

20. The audio decoding device according to claim 11, further comprising a demultiplexing and decombining unit (250) for demultiplexing and decombining parameters received from a transmission channel.

21. An audio transmission system, comprising an audio encoding device (100), comprising first encoding means (101, 111) for encoding transient signal components and/or sinusoidal signal components of an audio signal and producing a residual signal, and second encoding means for encoding the residual signal, wherein the second encoding means comprise filter means (122, 125) for selecting at least one frequency band of the residual signal, and wherein the second encoding means further comprise at least a first encoding unit (123, 126) and a second encoding unit (124, 121) for encoding the selected frequency band and an additional frequency band of the residual signal respectively and an audio decoding device (200) according to claim 11.

22. A method of encoding an audio signal, the method comprising the steps of encoding transient signal components and/or sinusoidal signal components of the audio signal and producing a residual signal, and encoding the residual signal, wherein the step of encoding the residual signal comprises the sub-steps of selecting a frequency band of the residual signal, and encoding the selected frequency band and an additional frequency band of the residual signal separately.

23. The method according to claim 22, wherein the selected frequency band (LF; 0) comprises relatively low frequencies and the additional frequency band (HF; 1) comprises relatively high frequencies.

24. The method according to claim 22, wherein the additional frequency band (HF; 1) is also a selected frequency band.

25. The method according to claim 22, wherein the additional frequency band (HF; 1) comprises substantially the entire frequency range of the residual signal.

26. The method according to claim 22, wherein the step of encoding the selected frequency band (LF; 0) comprises waveform encoding and wherein the step of encoding the additional frequency band (HF; 1) comprises noise encoding.

27. The method according to claim 26, wherein the step of encoding the selected frequency band (LF; 0) comprises Analysis-by-Synthesis (AS) encoding.

28. The method according to claim 26, wherein the step of encoding the selected frequency band comprises Regular Pulse Excitation (RPE) encoding, Multiple Pulse Excitation (MPE) encoding, and/or Code-Excited Linear Prediction (CELP) encoding.

29. A method of decoding an audio signal encoded by the method of claim 22, the method comprising the steps of decoding transient signal components and/or sinusoidal signal components of the audio signal, and decoding a residual signal, wherein the step of decoding the residual signal comprises the sub-steps of decoding a first frequency band (LF; 0) and a second frequency band (HF; 1) of the residual signal separately, and combining the thus decoded frequency bands.

30. The method according to claim 29, wherein the sub-step of decoding a first frequency band (LF; 0) comprises waveform decoding and wherein the sub-step of decoding a second frequency band comprises noise decoding.

31. The method according to claim 30, wherein the step of decoding the selected frequency band (LF; 0) comprises Analysis-by-Synthesis (AS) decoding.

32. The method according to claim 30, wherein the sub-step of decoding a first frequency band (LF; 0) comprises Regular Pulse Excitation (RPE) decoding, Multiple Pulse Excitation (MPE) decoding, and/or Code-Excited Linear Prediction (CELP) decoding.

33. The method according to claim 29, further comprising the sub-step of additionally decoding the first frequency band (LF; 0) and/or the second frequency band (HF; 1) utilizing a different decoding technique.

34. The method according to claim 33, further comprising the sub-step of selectively using either the originally decoded frequency band or the additionally decoded frequency band.

35. A computer program product for carrying out the method according to claim 22.
